(19) United States
(12) Patent Application Publication
(10) Pub. No.: US 2003/0060068 A1
(43) Pub. Date: Mar. 27, 2003

(54) Connector assembly for vehicle electric equipment circuit

(75) Inventor: Masanori Kunugi, Shizuoka-ken (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 10/247,634

(22) Filed: Sep. 20, 2002

(30) Foreign Application Priority Data
Sep. 21, 2001 (JP) P 2001-289537

(51) Int. Cl. H01R 13/53

(52) U.S. Cl. 439/181

(57) ABSTRACT

The connector assembly includes a first connector (10) with female terminals (10e), upstream from a power supply (2) in a circuit for vehicle electric equipment. The assembly includes a second connector (11) with male terminals (11d), downstream from the power supply in the circuit. The second connector is mated with the first connector. The first and second connectors include a connector connection interconnecting the power supply and a load (6).

### BACKGROUND OF THE INVENTION

1. Field of the Invention

The present invention relates to a connector assembly, which allows a pair of connectors with male and female terminals to join a circuit for vehicle equipment.

2. Description of Relevant Art

Recently, an automotive for a high-voltage of 42 V advances in development. The automotive is equipped with a motor generator with an advantageous fuel cost. The high-voltage automotive has a voltage three times as great as 14V of a vehicle current power supply. The voltage causes arc-discharge or short-circuit during line assembly or service to become three times in probability. This necessitates a counter-plan due to maintenance and prevention against disaster.

### SUMMARY OF THE INVENTION

The present invention is directed to a connector assembly, which prevents short-circuit or arc-discharge during handling of connectors, thus improving maintenancability or preventionability against disaster.

A first aspect of the invention is directed to a connector assembly. The assembly includes a first connector with female terminals, upstream from a power supply in a circuit for vehicle electric equipment. The assembly includes a second connector with male terminals, downstream from the power supply in the circuit. The second connector is mated with the first connector. The first and second connectors include a connector connection therebetween interconnecting the power supply and a load.

Preferably, the second connector includes a connector insertion opening for arranging the male terminals inside the insertion openings.

Preferably, the first connector includes a projection to be inserted into the connector insertion opening. The projection includes terminal insertion openings for arranging the female terminals therein.

Preferably, the projection includes partitions for separating the terminal insertion openings from each other.

Preferably, the circuit includes a power supply-side and a load-side. The first connector connects to the power supply-side. The second connector connects to the load-side.

### BRIEF DESCRIPTION OF THE ACCOMPANYING DRAWINGS

FIGS. 1A, 1B and 1C show an embodiment of a connector assembly according to the invention;

FIG. 1A is a primary block diagram of a vehicle electric equipment circuit;

FIG. 1B is a perspective view of a connector with a female terminal; and

FIG. 1C is a perspective view of a connector with a male terminal; and

FIG. 2 is a perspective view of the male and female terminals in FIGS. 1B and 1C.

### DETAILED DESCRIPTION OF THE PREFERRED EMBODIMENTS

An embodiment of the present invention will hereby be described with reference to the drawings.

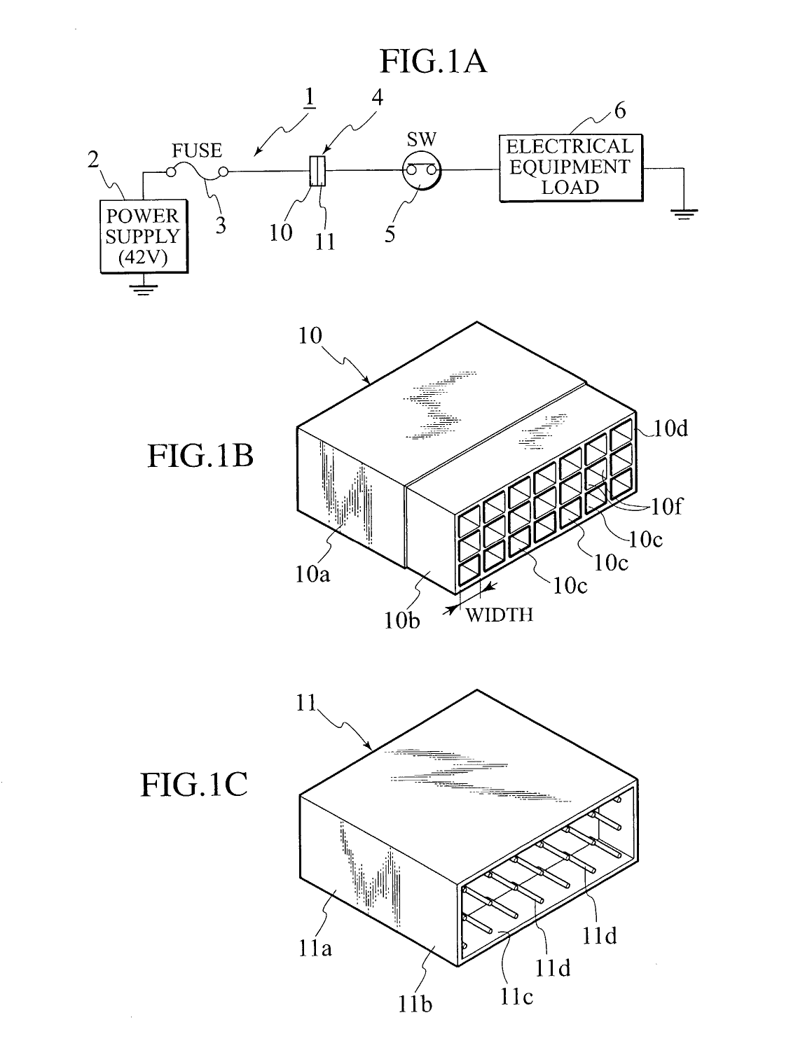

As shown on FIG. 1A, vehicle electric equipment circuit 1 includes power supply 2, which supplies a power voltage of 42V. Circuit 1 includes fuse 3, which prevents application of overcurrent. Circuit 1 includes a connector connection 4, which interconnects wire-harness. Circuit 1 includes electric equipment load 6, which is actuated by power supply 2. Circuit 1 includes switch 5, which allows actuation of electric equipment load 6. These constitute primary components. Connector connection 4 includes connector 10 and 11 with female and male terminals 10e and 11d. Connector 10 is arranged upstream from power supply 2, or is connected to an end of the power supply 2. Connector 11 is arranged downstream from power supply 2, or is connected to an end of load 6.

Connector 11 includes connector casing 11a in FIG. 1C. Connector 11 includes hood 11b, which extends from the insertion end from casing 11a. Hood 11b includes an internal space, serving as connector insertion opening 11c. Casing 11a has insertion end face 11f, from which male terminals 11d extend. Terminals 11d are arranged within opening 11c. Respective terminals 11d connect to respective lines downstream from power supply 2 in casing 11a.

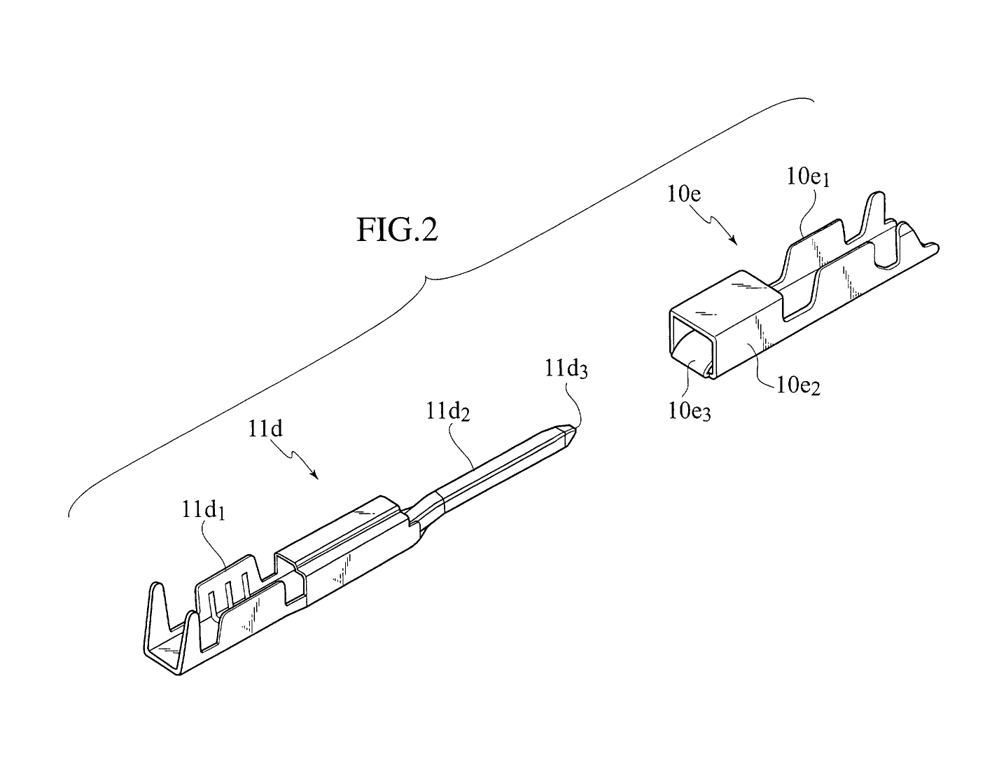

Connector 10, as shown in FIG. 1B, includes connector casing 11a. Casing 10a includes an end face, which has connector projection 10b for inserting into opening 11c. Projection 10b includes insertion end face 10d, which opens terminal insertion openings 10c. Each of openings 10c includes an interior, where female terminal 10e of FIG. 2 are placed. Respective female terminals 10e connect to corresponding lines upstream from power supply 2 in casing 10a.

Projection 10b includes vertical and transverse partitions 10f, which separates openings 10c from each other. The partitions 10f prevent short-circuit between female terminals 10e.

Each of male terminals 11d includes a crimping part 11d1 and a connecting protrusion 11d2 extending from the crimping part 11d1. The protrusion 11d2 includes sharp contact 11d3 at the tip, which has a great curvature to cause locally large electric field.

Each of female terminals 10e includes a crimping part 10e1 and a looped receiver 10e2 extending from the crimping part 10e1. Receiver 10e2 includes contact 10e3, which has a smaller curvature than contact 11d3. Thus, contact 10e3 has no tendency to produce arc-discharge, comparing to contact 11d3.

During assembly, each of male terminals 11d is inserted into opening 11c. Contact 11d3 come close to mating contact 10e3. At this time, no arc-discharge occurs between contacts 11d3 and 10e3. Contact 11d3 reaches contact 10e3, thus establishing electric conduction. Protrusion 11d2 is inserted into receiver 10e2, and is resiliently retained in receiver 10e2.

During assembly or removal of connectors 10, 11, connector 10 connects to the upstream from power supply 2, and a power voltage is applied to connector 10. Connector 10 has female terminals 10e, which are housed within openings 10c of a narrow width. Thus, there is no possibility for fingers to come close to or in contact with female terminals 10e, and no possibility of short-circuit or arc-discharge during the handling of connection 4.

According to the invention, during handling of the connector, prevention of short-circuit or arc-discharge improves maintenancability and preventionabiity against disaster.

The entire contents of Japanese Patent Applications P2001-2889537 (filed on Sep. 21, 2001) are incorporated herein by reference.

Although the invention has been described above by reference to certain embodiments of the invention, the invention is not limited to the embodiment described above. Modifications and variations of the embodiments described above will occur to those skilled in the art, in light of the above teachings. The scope of the invention is defined with reference to the following claims.

What is claimed is:

1. A connector assembly comprising:
a first connector with female terminals, upstream from a power supply in a circuit for vehicle electric equipment; and
a second connector with male terminals, downstream from the power supply in the circuit, the second connector mated with the first connector,
wherein the first and second connectors include a connector connection therebetween interconnecting the power supply and the load.

2. The connector assembly according to claim 1, wherein the second connector includes a connector insertion opening for arranging the male terminals inside the insertion openings.

3. The connector assembly according to claim 2,
wherein the first connector includes a projection to be inserted into the connector insertion opening;
wherein the projection includes terminal insertion openings for arranging the female terminals therein.

4. The connector assembly according to claim 3,
wherein the projection includes partitions for separating the terminal insertion openings from each other.

5. The connector assembly according to claim 1,
wherein the circuit includes a power supply-side and a load-side,
wherein the first connector connects to the power supply-side, and
wherein the second connector connects to the load-side.
